(19) United States
(12) Patent Application Publication
(10) Pub. No.: US 2003/0088641 A1
(43) Pub. Date: May 8, 2003

(54) Technical support system

(75) Inventor: Toshio Ueno, Hanno-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/002,744

(22) Filed: Nov. 2, 2001

(51) Int. Cl. G06F 15/16; G06F 17/30; G06F 7/00

(52) U.S. Cl. 709/218; 709/203; 707/3

(57) ABSTRACT

A technical support system includes a SIP section which provides web pages as an information input and output interface, a KB section which stores various claim reports and solutions answered by engineers with respect to the claim reports, and a CH section which searches the KB section for solutions which match a claim content input to a client web page. Particularly, the CH section is configured to perform an ordinary search of collecting the claim reports based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search.

### BACKGROUND OF THE INVENTION

The present invention relates to technical support system for providing technical support to various claims for a manufacturer's own products acquired through a worldwide technical service network.

In recent years, many enterprises have overseas subsidiaries established as footholds for the marketing of products. In a typical enterprise, the subsidiaries sell products to end-users via, e.g. distributors and dealers. Besides, technical services such as maintenance and repair of products are provided to end-users from the dealers and direct service organizations. Major subsidiaries handle various claims reported directly from the dealers and direct service organizations in their assigned marketing regions, or indirectly from the distributors and subsidiaries. If the major subsidiaries have received claims that cannot be handled, they report such claims to an engineering and service department of the headquarters.

The engineering and service department acts as an agent between the subsidiary, which is a customer, and a product technology department of a factory or a third party vender. The engineering and service department demands a solution to the claim reported by the subsidiary from an engineer in charge in the product technology department. The engineer confirms the content of the claim, studies the cause of the claim, and carries out a supporting task for preparing the solution that can eliminate the cause. The engineering and service department confirms the solution provided by the engineer after the supporting task, produces a claim handling plan based on the solution, so as to meet individual technical support policies varying from market to market, and delivers the claim handling plan to the subsidiary as an answer document to the claim.

In the prior art, the dealers, direct service organizations, distributors, subsidiaries, major subsidiaries, engineering and service department, and product technology department are connected over a dedicated line or the Internet so as to have a hierarchical structure, as shown in FIG. 1. E-mail is used as an information transmission media. In the technical support, each service layer is always required to search databases, etc. to find solutions to claim reports, which have been sent from a lower-level service layer by e-mail. If solutions are not found, each service layer is required to request an upper-level service layer. Thus, arrears of claim reports may possibly occur in an escalation from the lowermost service layer to the uppermost service layer.

Since the main task of the product technology department is designing and manufacture of products, a delay in the support task will often occur even if it receives a request from the engineering and service depart. In such a situation that the supporting task cannot be started, the supporting task has to be suspended, or the cause of the claim cannot easily be identified.

Moreover, the engineering and service department cannot completely grasp the condition of progress in the delayed supporting tasks, and unsolved claim reports tend to accumulate. Besides, a solution to a claim that has arisen in connection with a product is not necessarily applicable to a similar claim that has arisen in connection with another product sold in a different market in which different product specifications are adopted. Thus, the engineering and service department needs to accept all claim reports from the subsidiaries that manage different markets.

Under the circumstances, the above-described technical support system will ultimately impose a heavy load on the engineering and service department and it would be difficult to fulfill their roles in the future without increasing the scale thereof.

### BRIEF SUMMARY OF THE INVENTION

The object of the present invention is to provide a technical support system capable of quickly solving claims relating to products.

According to the present invention, there is provided a technical support system comprising: a service information portal section which provides web pages as an information input and output interface; a knowledge base section which stores various claim reports and solutions answered by engineers with respect to the claim reports; and a claim handling section which searches the knowledge base section for solutions which match a claim content input to a client web page; wherein the claim handling section is configured to perform an ordinary search of collecting the claim reports from the knowledge base section based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search.

With the technical support system, the claim handling section performs an ordinary search of collecting the claim reports from the knowledge base section based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search. Therefore, it is possible to find the solution which matches the claim content at a high precision. When the solution is found as a result of searching, the claim can quickly be solved without requiring any answer from the engineers.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is a diagram showing a hierarchical structure of a conventional technical service;

FIG. 2 is a diagram showing the structure of a technical support system according to an embodiment of the present invention, and a network connected to the technical support system;

FIG. 3 is a diagram showing a flow of information in the technical support system shown in FIG. 2;

FIG. 4 is a diagram showing an example in which the technical support system shown in FIG. 2 is applied to a conventional hierarchical structure;

FIG. 5 is a flowchart of a claim reporting process performed in a CH section in the technical support system shown in FIG. 2;

FIG. 6 is a flowchart of a knowledge base search process shown in FIG. 5 in greater detail;

FIG. 7 is a diagram showing a code table referred to in the ordinary search shown in FIG. 6 in order to obtain a type code specifying the type of a problem;

FIG. 8 is a diagram showing a code table referred to in the ordinary search shown in FIG. 6 in order to obtain a unit code specifying a unit corresponding to a problem occurring position;

FIG. 9 is a diagram showing a code table referred to in the ordinary search shown in FIG. 6 in order to obtain an error code specifying an error caused by the problem;

FIG. 10 is a diagram showing a synonym table referred to in an extended search shown in FIG. 6 in order to convert synonymous terms indicative of the problem into a single standard term;

FIG. 11 is a diagram showing a synonym table referred to in the extended search shown in FIG. 6 in order to converts synonymous terms indicative of the unit corresponding to the problem occurring position into a single standard term;

FIG. 12 is a diagram showing a synonym table referred to in the extended search shown in FIG. 6 in order to convert synonymous terms indicative of a cause of the problem into a single standard term;

FIG. 13 is a diagram showing a synonym table referred to in the extended search shown in FIG. 6 in order to convert synonymous terms indicative of a treatment for the problem into a single standard term;

FIG. 14 is a diagram showing a claim report prepared by the claim reporting process shown in FIG. 5; and

FIG. 15 is a diagram showing detailed contents of items incorporated in the claim report shown in FIG. 14.

### DETAILED DESCRIPTION OF THE INVENTION

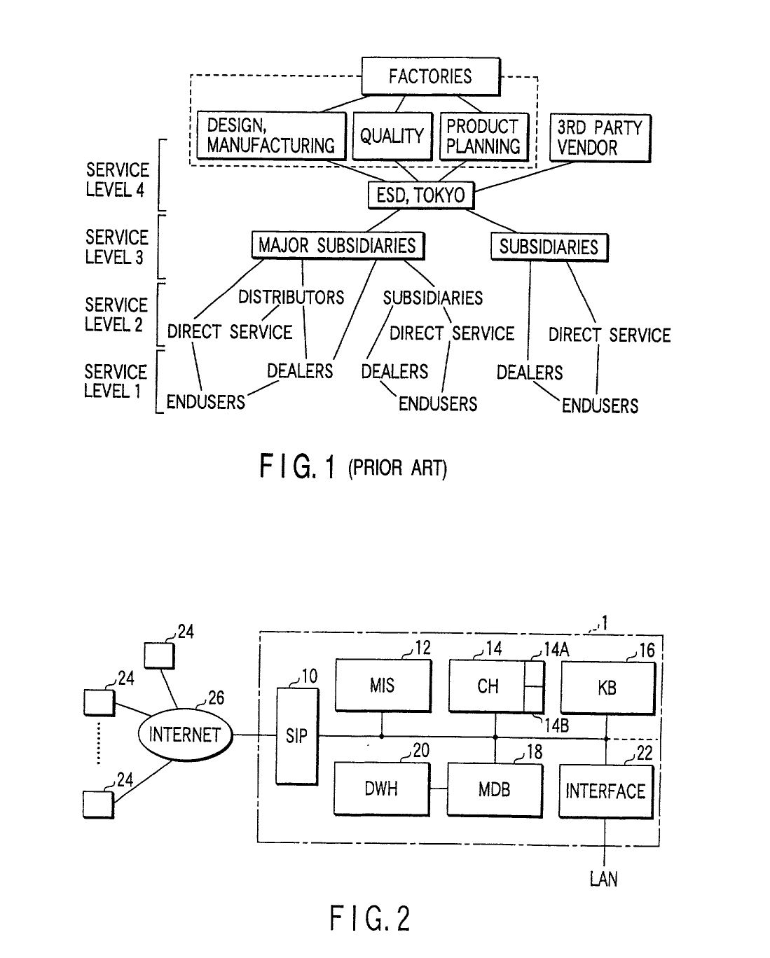

A technical support system 1 according to an embodiment of the present invention will now be described with reference to the accompanying drawings. The technical support system 1 is constructed to be also applicable to a hierarchical structure of technical service shown in FIG. 1, and serves as a server disposed in an engineering and service department in Tokyo, for example. This server is connected over the Internet to worldwide major subsidiaries as clients, which serve as sales footholds of products such as copiers and facsimile machines. The server, on behalf of staff of the engineering and service department, functions as an agent between the customer and the product technology department of the factory or third party vender.

FIG. 2 shows the technical support system 1 and a network connected thereto. The technical support system 1 comprises a service information portal (SIP) section 10, a management information system (MIS) section 12, a claim handling (CH) section 14, a knowledge base (KB) section 16, a master database (MDB) section 18, a data warehouse (DWH) section 20, and a communication interface 22. The SIP section 10, MIS section 12, CH section 14, KB section 16, MDB section 18, DWH section 20 and communication interface 22 for intra-company LAN are constructed as a combination of plural server computers connected, for example, over a shared system bus. The MIS section 12 and CH section 14 are incorporated into the technical support system 1 as application software of the server computers.

The SIP section 10 provides web pages to client terminals 24 over the Internet 26 as an information input and output interface. The MIS section 12 can access the client terminals 24 via the SIP section 10 and it collects and analyzes various report information. The master database 18 stores the overall information collected by the MIS section 12 as well as other information. The DWH section 20 stores an analysis tool for enabling the MIS section 12 to analyze the information stored in the MDB section 18. The KB section 16 stores various claim reports backed up also in the MDB section 18 and solutions answered by engineers of the product technology department with respect to the claim reports. The CH section 14 registers in the KB section 16 a new claim report in which at least a claim title is structured as combinations of predetermined items of definition information on the basis of claims input to the client web page provided by the SIP section 10. The CH section 14 manages the new claim report as an unsolved claim requiring an answer from engineers.

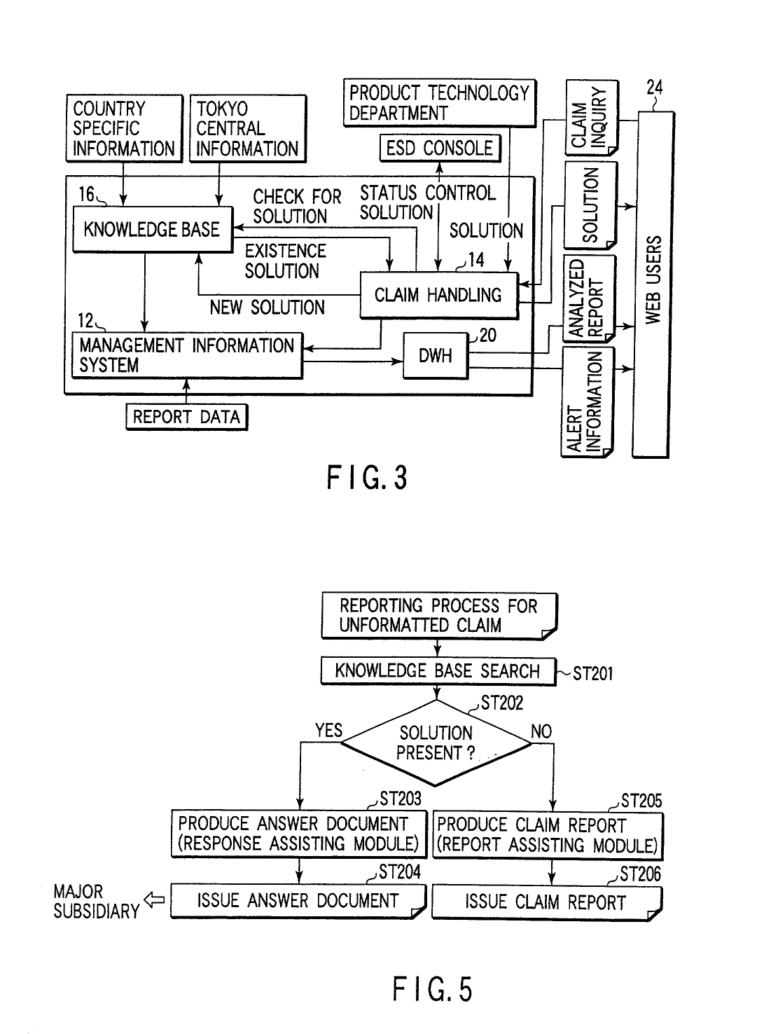

FIG. 3 shows a flow of information in the technical support system 1. If the client terminal 24, or a web user, issues a claim inquiry, it is delivered to the CH section 14 as a claim report. The CH section 14 checks the KB section 16 for a solution to the claim, and acquires the solution from the KB section 16. If there is no solution, the CH section 14 requests a solution from the product technology department and registers an acquired solution in the KB section 16 as a new solution. At the same time, the CH section 14 informs the client of the new solution as an answer document. The KB section 16 stores not only various reports and solutions thereto, but also country specific information and Tokyo central information supplied from the intra-company LAN. The country specific information includes individual technical support policies varying from market to market, the Tokyo central information includes inside materials and third party materials of related technologies. The CH section 14 is so constructed as to permit an operator working at the engineering and service department to confirm, through a console of the server computer, the current state of support for unsolved claim reports. The MIS section 12 collects various report information such as warrantee report data, call center data, set-up report data, service parts use data and claim report data, which are accumulated in the client terminal 24 side.

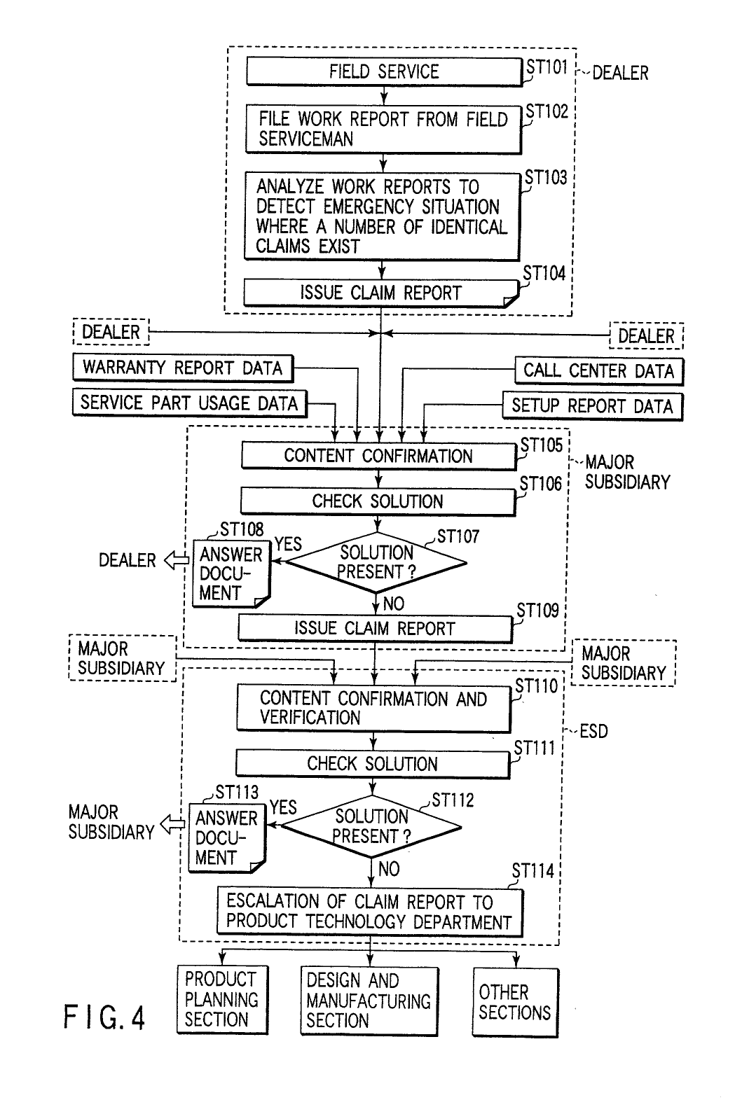

FIG. 4 shows an example wherein the technical support system 1 is applied to the conventional hierarchical structure shown in FIG. 1. In this example, the major subsidiaries alone are permitted to access the technical support system 1 via the Internet 26. None of the dealers, direct service organizations, distributors and ordinary subsidiaries are permitted to access the technical support system 1. In the dealership, a field serviceman performs, in step ST101, a field service such as maintenance and repair of products. In step ST102, if a work report from the field serviceman is filed after the field service, the work report is analyzed in step ST103. If an emergency situation where a number of identical claims exist is detected, a claim report is issued in step ST104 to the major subsidiary, which is an upper-level service layer.

In major subsidiaries, an employee confirms, in step ST105, the content of the claim report along with the independently collected various report information such as warrantee report data, call center data, set-up report data, service parts use data and claim report data. Then, the computer operator registers the confirmed information in the database. In step ST106, the operator checks the database for an existing solution to the claim of the claim report. If it is determined in step ST107 that the solution is present in the database, an answer document based on the solution is sent to the dealer in step ST108. On the other hand, if there is no existing solution, the operator accesses, in step ST109, the technical support system 1 in Tokyo over the Internet 26, which is an upper-level service layer. The claim is reported to the engineering and service department through the client web page, which is provided to the client terminal 24 of the major subsidiary by the technical support system 1.

In the engineering and service department, in step ST110, the technical support system 1 confirms and verifies the content of the claim report. In step ST111, it is checked whether there is a solution to the claim. If it has been determined in step ST112 that the solution is present in the database, an answer document based on this solution is sent to the major subsidiary in step ST113. On the other hand, if the solution is not present, the claim report is escalated to the product technology department at the upper service level in step ST114. In a case where the product technology department comprises, for example, a product planning section, a design and manufacturing section, and other sections, one of these sections is designated and a solution to the claim is requested therefrom. In FIG. 4, all the steps beginning with step ST110 are carried out within the technical support system 1.

FIG. 5 shows a claim reporting process performed by the CH section 14 in the technical support system 1. When the reporting process is selected on the client web page, the CH section 14 performs a knowledge base search process to search the KB section 16 for solutions which match the claim content input from the web page in step ST201. The claim content includes product information and claim details of a natural language form. As a search result, it is detected in step ST202 that the solution is present in the KB section 16. Then, the answer document reflecting the solution is automatically produced using a response assisting module 14A in step ST203, and issued to the major subsidiary in step ST204. The response assisting module 14A produces the answer document so as to meet the technical support policy which differs from market to market. On the other hand, when any solution to the similar claim is not present in the KB section 16, a claim report is newly produced using a report assisting module 14B in step ST205, and issued in step ST206. The report assisting module 14B automatically incorporates into the claim report the information available from the content of the claim input to the client web page, and requests input of information which is necessary for a study of a solution by the engineer but is lacking.

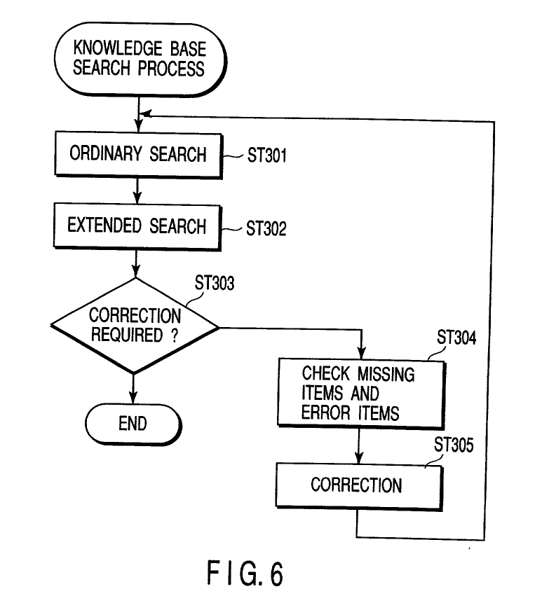

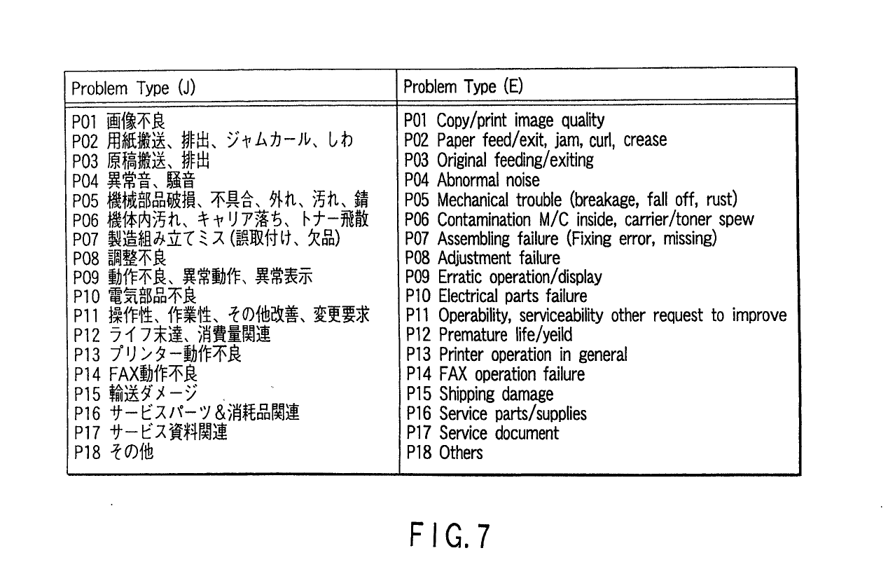

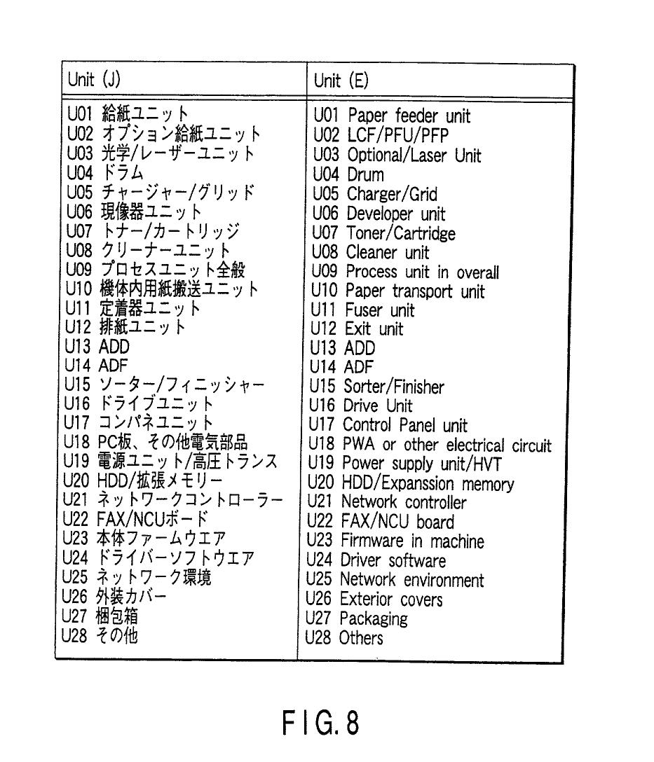

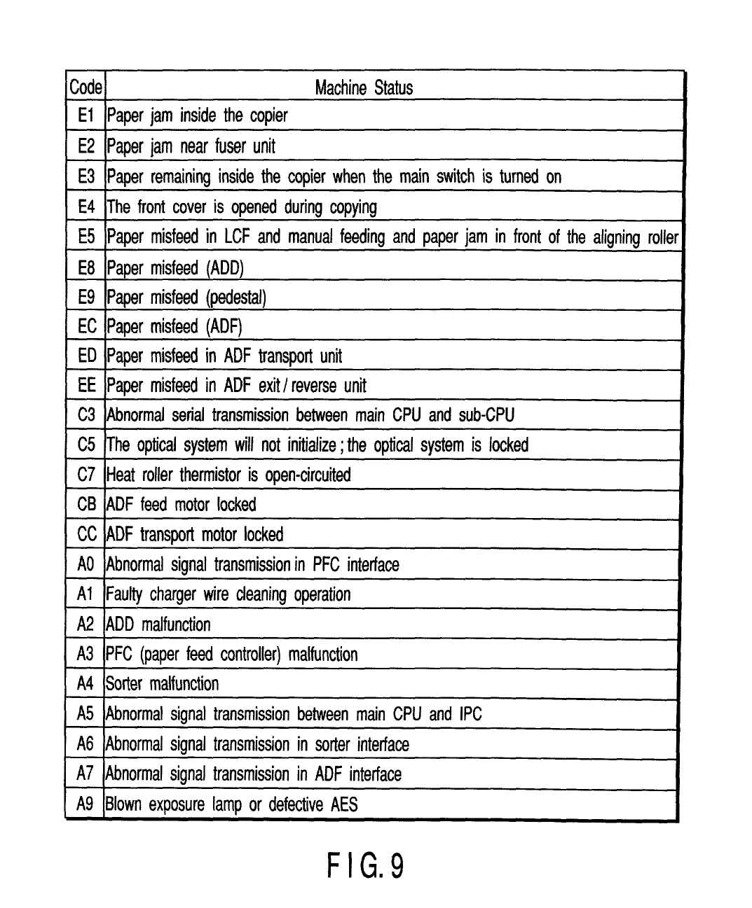

FIG. 6 shows the knowledge base search process in greater detail. In the knowledge base search process of FIG. 6, the CH section 14 performs in step ST301 an ordinary search of collecting claim reports from the KB section 16 based on product information input as the claim content. The product information includes predetermined items such as a product model, problem, problem occurring position, error, troubled part, production environment, and software. The product model is represented by a model number. The CH section 14 refers, for example, to code tables shown in FIGS. 7 to 9 to encode the product information described in various local languages. The code table shown in FIG. 7 is referred to in order to obtain a type code specifying the type of a problem. The code table shown in FIG. 8 is referred to in order to obtain a unit code specifying a unit corresponding to the problem occurring position. The code table shown in FIG. 9 is referred to in order to obtain an error code specifying an error caused by the problem. The troubled part is represented by a troubled part code or a troubled part name. The production environment is represented by a production code or a lot number indicating a product manufacturing factory and production month. The software is represented by a software number specifying the type and version of firmware and printer driver, a software code or software number specifying the type and version of an operation system, and a software number specifying the type and version of application software. The CH section 14 collects the claim reports by using the product information obtained in this manner as keywords for searching the KB section 16.

Aside from the above-mentioned code tables, it is possible to provide tables applicable to cases where different model numbers are assigned to the same model in different countries. In the synonym tables shown in FIGS. 6 and 7, English and Japanese synonyms are associated with the same code. However, these tables may be disposed in the system as a conversion table for unifying languages by converting, for example, Japanese or German terms to the terms of a standard language such as English. Thereby, it becomes possible to find a solution to similar claims from major subsidiaries managing other market regions.

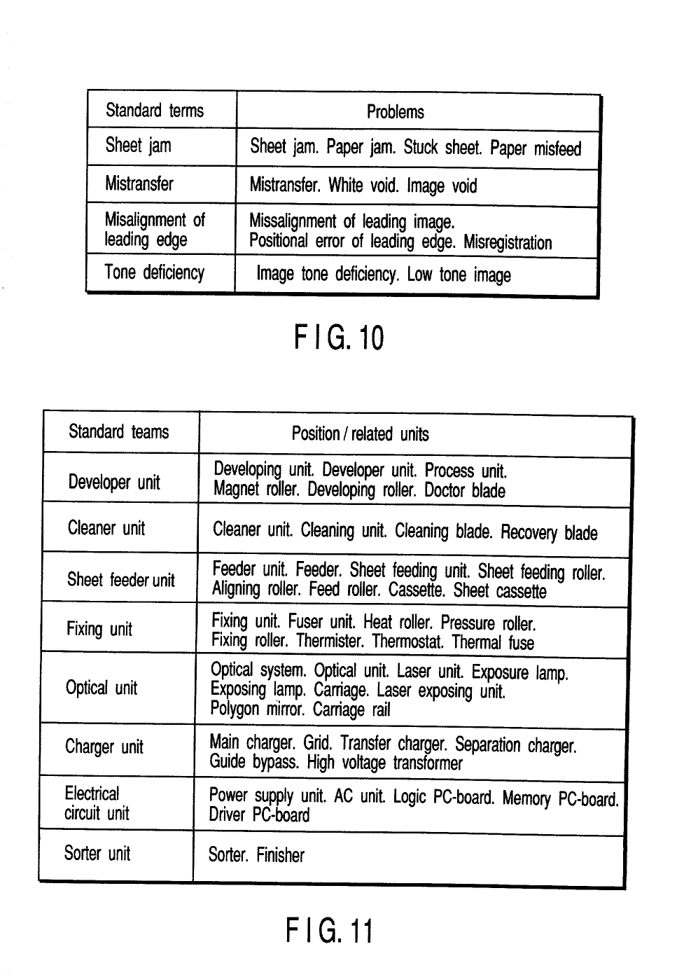

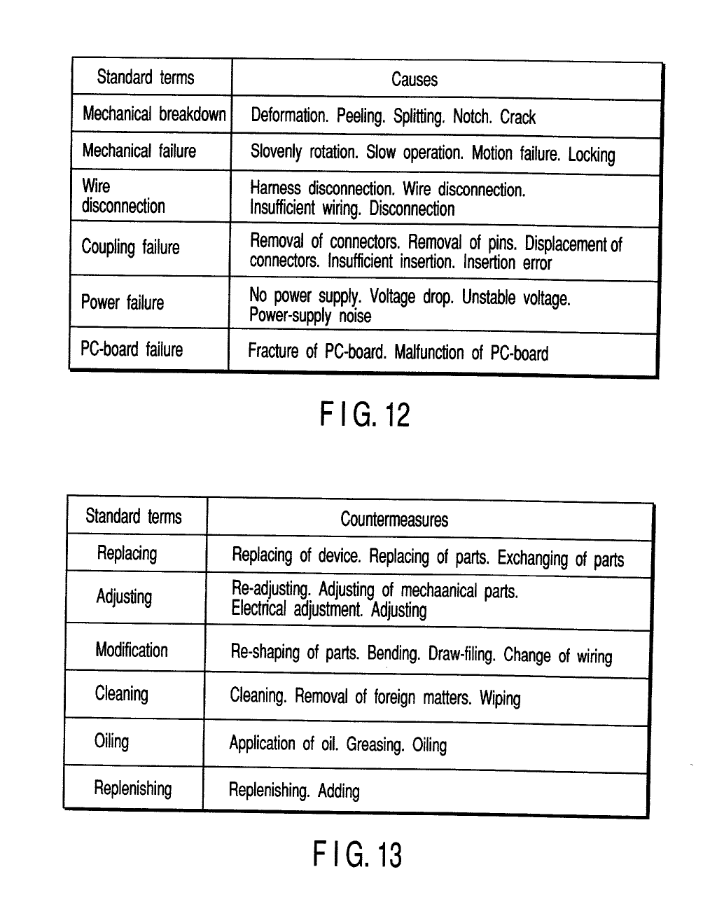

In the KB section 16, various claim reports are managed in a form structured as a combination of terms indicating four items of claim definition information such as the problem, problem occurring unit, cause, and treatment. Therefore, after the ordinary search, the CH section 14 performs in step ST302 an extended search of extracting the four items of claim definition information from claim details of a natural language form input as the claim content, and derives a reduced number of solution candidates based on the combination of the claim definition information items from the claim reports collected in the ordinary search. In the extended search, the CH section 14 refers to synonym tables shown in FIGS. 10 to 13. The synonym table shown in FIG. 10 is referred to in order to convert synonymous terms having the same technical meaning for the problem into a single standard term. The synonym table shown in FIG. 11 is referred to in order to convert synonymous terms having the same technical meaning for the problem occurring position into a single standard term. The synonym table shown in FIG. 12 is referred to in order to convert synonymous terms having the same technical meaning for the cause of the problem into a single standard term. The synonym table shown in FIG. 13 is referred to in order to convert synonymous terms having the same technical meaning for the treatment for the problem into a single standard term. Even when the claim details are freely described in different terms with respect to the same matter, the claim definition information of the four items are extracted from the claim details in the standard term, and it is therefore possible to derive a reduced number of solution candidates based on the combination of the claim definition information items from the claim reports obtained in the ordinary search.

Additionally, the reduced number of solution candidates do not have to be derived using the combination of all the claim definition information items, and they may be derived using one, two, or three of the claim definition information items.

After the extended search, in step ST303 the CH section 14 checks whether or not correction of the product information is required. If many claim reports remain, and the number of solution candidates are not sufficiently reduced, the CH section 14 checks missing items and error items of the product information input as the claim content in step ST304, and performs a correction process of the product information based on the claim definition information items extracted in the standard term in the aforementioned extended search in step ST305. When there is missing information in problem information such as problem type and problem occurring unit, the CH section 14 replaces the missing information with the claim definition information item extracted in the standard term from the claim details in the extended search. Moreover, when the claim definition information item extracted from the claim details is inconsistent with the content of product information, the CH section 14 requires confirmation as to whether or not the product information is correct. After the content of product information is corrected, the steps ST301, ST302, ST303 are executed again. This varies the collection range of the claim reports to enhance the precision in deriving of the reduced number of solution candidates.

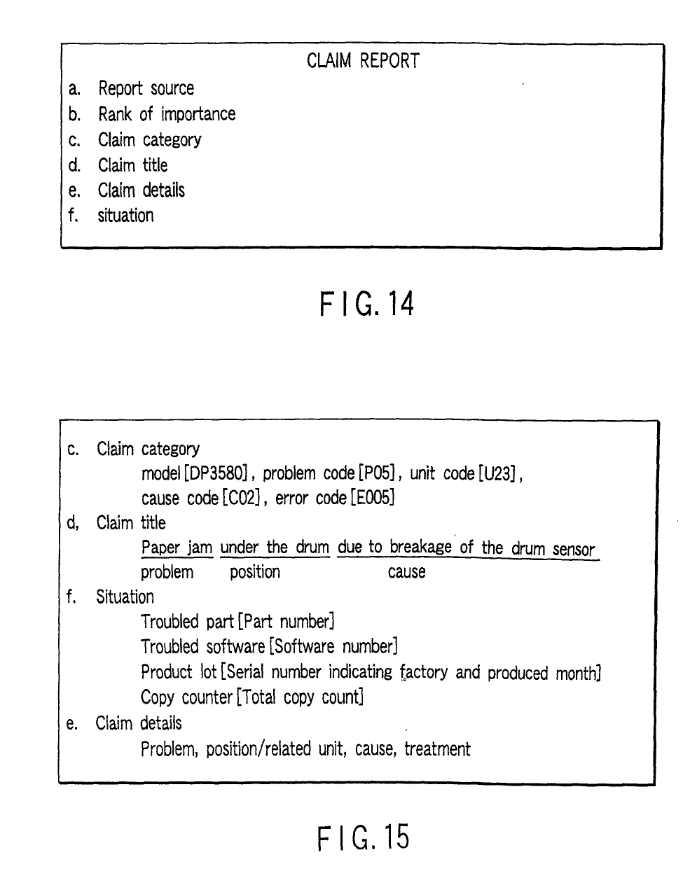

FIG. 14 shows an example of the claim report prepared by the claim reporting process. The claim report includes information such as a: report source, b: rank of importance, c: claim category, d: claim title, e: claim details, and f: situation.

FIG. 15 shows detailed contents of the items c, d, e, f incorporated in the claim report. Item c of the claim category includes a product model number, problem type code, unit code, cause code, and error code. Item d of the claim title is prepared as a phrase constructed by combining words indicative of the definition information items such as a problem, a position, and a cause. Examples of the claim title other than that shown in FIG. 15 are “Dark copy image due to poor adjustment in optical unit”, “Abnormal noise from drive gear in fuser unit”, and “Breakage of front cover due to poor package material”. Item e of the claim details is prepared as free description including claim definition information items such as the problem, occurring position, cause, and treatment. Item f of occurrence situation is prepared to include a product number, software version number, troubled part number, and total copy counter value.

In the technical support system 1 of the aforementioned embodiment, the CH section 14 registers in the knowledge base section a new claim report in which a claim title is structured as a combination of predetermined items of definition information on the basis of a claim content input to the client web page. The CH section 14 manages the registered new claim report as an unsolved claim that requires an answer from the engineer. Moreover, the CH section 14 performs a knowledge search for confirming the presence of similar claims specified by information available from the claim content input to the client web page in a format close to a natural language, for example, information on product units or problems.

In the knowledge base search, the CH section 14 performs the ordinary search of collecting the claim reports based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search. Therefore, it is possible to find the solution which matches the claim content at a high precision. When the solution is found as a result of searching, the claim can quickly be solved without requiring any answer from the engineers.

Moreover, since the product units and problems expressed in various local languages are converted to unit codes and problem codes, for example, using synonym tables, the precision in the search does not depend on the languages in the market regions.

When a solution is obtained by the knowledge search, an answer document based on the solution is automatically produced using the response assisting module 14A and the answer document is issued to the major subsidiary. The response assistance module 14A produces the answer document so as to meet the technical support policy which differs from market region to market region. Therefore, suitable answers can be produced for subsidiaries in various market regions.

On the other hand, even if a solution to similar claims is not obtained, a claim report is newly produced using the report assistance module 14B. The report assisting module 14B automatically incorporates into the claim report the information available from the content of the claim input to the client web page, and requests input of information which is necessary for a study of a solution by the engineer but is lacking. Based on the information input in response to this request, the claim report is formatted. Therefore, defects in the claim report can be effectively removed.

In the above-described embodiment, the technical support system 1 has been described as processing claims relating to products such as copiers and facsimile machines. However, the present invention is not limited to this embodiment. The present invention is applicable not only to the worldwide technical service network, but also to a case where plural market regions are present in a single country. Moreover, at least one of the SIP section 10, MIS section 12, CH section 14, KB section 16, MDB section 18, and DWH section 20 of the technical support system 1 may be composed of a server computer, in which application software of the functions described in connection with the above embodiment is installed from a recording medium or downloaded via the interface 22.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A technical support system comprising:
a service information portal section which provides web pages as an information input and output interface;
a knowledge base section which stores various claim reports and solutions answered by engineers with respect to the claim reports; and
a claim handling section which searches said knowledge base section for solutions which match a claim content input to a client web page;
wherein said claim handling section is configured to perform an ordinary search of collecting the claim reports from said knowledge base section based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search.

2. The technical support system according to claim 1, wherein said claim handling section is configured to check a missing item of the product information based on the claim definition information obtained in the standard term in said extended search, and fill out the missing item of the product information with the standard term.

3. The technical support system according to claim 2, wherein said claim handling section is configured to check an error item of the product information based on the claim definition information obtained in the standard term in said extended search, and requires confirmation as to whether or not the product information is correct, when the claim definition information is inconsistent with a content of the product information.

4. The technical support system according to claim 1, wherein said claim handling section is configured to check an error item of the product information based on the claim definition information obtained in the standard term in said extended search, and requires confirmation as to whether or not the product information is correct, when the claim definition information is inconsistent with a content of the product information.

5. The technical support system according to claim 1, wherein said claim handling section includes a synonym table which is referred to in the extended search to convert synonymous terms indicative of a problem into a single standard term.

6. The technical support system according to claim 1, wherein said claim handling section includes a synonym table which is referred to in the extended search to convert synonymous terms indicative of a unit corresponding to a problem occurring position into a single standard term.

7. The technical support system according to claim 1, wherein said claim handling section includes a synonym table which is referred to in the extended search to convert synonymous terms indicative of a cause of a problem into a single standard term.

8. The technical support system according to claim 1, wherein said claim handling section includes a synonym table which is referred to in the extended search shown to convert synonymous terms indicative of a treatment for a problem into a single standard term.

9. A recording medium with a program for a technical support system server which includes a service information portal section which provides web pages as an information input and output interface, a knowledge base section which stores various claim reports and solutions answered by engineers with respect to the claim reports, and a claim handling section which searches said knowledge base section for solutions which match a claim content input to a client web page, said program being arranged for causing said claim handling section to perform an ordinary search of collecting the claim reports from said knowledge base section based on product information input as the claim content, and an extended search of extracting predetermined items of claim definition information in a standard term from claim details of a natural language form input as the claim content by referring to a synonym table which converts synonym terms having the same technical meaning into the single standard term and then deriving a reduced number of solution candidates based on a combination of the claim definition information items from the claim reports obtained in the ordinary search.

10. The recording medium according to claim 9, wherein said program is arranged for causing said claim handling section to check a missing item of the product information based on the claim definition information obtained in the standard term in said extended search, and fill out the missing item of the product information with the standard term.

11. The recording medium according to claim 9, wherein said program is arranged for causing said claim handling section to check an error item of the product information based on the claim definition information obtained in the standard term in said extended search, and requires confirmation as to whether or not the product information is correct, when the claim definition information is inconsistent with a content of the product information.

12. A technical support method using a knowledge base section which stores various claim reports and solutions answered by engineers with respect to the claim reports, said method comprising:
an ordinary search step of collecting claim reports;
a step of extracting predetermined items of claim definition information in a standard term from claim of a natural language form input as the claim content by referring to a synonym table which converts synonym terms having the same technical meaning into the single standard term; and
an extended search step of deriving a reduced number of solution candidates based on a combination of the claim definition information items from the claim reports obtained in the ordinary search.

13. The technical support method according to claim 12, further comprising:
a step of checking a missing item of the product information based on the claim definition information obtained in the standard term in said extended search; and
a step of filling out the missing item of the product information with the standard term.

14. The technical support method according to claim 12, further comprising:
a step of checking an error item of the product information based on the claim definition information obtained in the standard term in said extended search; and
a step of requiring confirmation as to whether or not the product information is correct when the claim definition information is inconsistent with a content of the product information.
